(19) United States
(12) Patent Application Publication
(10) Pub. No.: US 2016/0127521 A1
(43) Pub. Date: May 5, 2016

(54) WLAN EXTENSION ELEMENTS

(71) Applicant: QUALCOMM Incorporated, San Diego, CA (US)

(72) Inventor: Maarten Menzo Wentink, Naarden (NL)

(21) Appl. No.: 14/708,915

(22) Filed: May 11, 2015

Related U.S. Application Data
(60) Provisional application No. 62/073,679, filed on Oct. 31, 2014.

(51) Int. Cl. H04L 29/06

(52) U.S. Cl. CPC H04L 69/22

(57) ABSTRACT

A system and method are disclosed that may increase the number of different element ID numbers that may be represented in an information element (IE) without significantly increasing the size of the IE and without altering existing parsers of various wireless devices. The IE may include a one-byte element ID field, a length field, an N-byte element ID extension field, and an information field 403. The one-byte element ID field may represent up to 2⁸=256 possible values; 255 of these 256 possible values may represent unique element ID numbers, and one of these 256 possible values may be designated as a pointer to the N-byte element ID extension field, which may store up to 2^{N} additional unique element ID numbers.

### CROSS-REFERENCE TO RELATED APPLICATIONS

This application claims priority to U.S. Provisional Patent Application No. 62/073,679 entitled “WLAN EXTENSION ELEMENTS” filed Oct. 31, 2014, the entirety of which is incorporated by reference herein.

### TECHNICAL FIELD

The example embodiments relate generally to wireless networks, and specifically to information elements used in frames transmitted in wireless networks.

### BACKGROUND OF RELATED ART

A wireless local area network (WLAN) may be formed by one or more access points (APs) that provide a shared wireless communication medium for use by a number of client devices or stations (STAs). Each AP, which may correspond to a Basic Service Set (BSS), periodically broadcasts beacon frames to enable any STAs within wireless range of the AP to establish and/or maintain a communication link with the WLAN. Once a STA is associated with the AP, the AP and the STA may exchange data frames. When the STA receives a data frame from the AP, the STA is to transmit an acknowledgment (ACK) frame back to the AP to acknowledge receipt of the data frame.

The IEEE 802.11 standards define a number of action frames and management frames (e.g., beacon frames, probe requests, probe responses, association frames, control frames, and so on) that may be transmitted between wireless devices over a shared wireless medium. Action frames and management frames may include an information element (IE) that contains information for the recipient device. For example, a beacon frame may include an IE containing an AP's timing synchronization function (TSF) value and beacon intervals, while a management frame may include an IE containing a service set identity (SSID) or supported data rates for the wireless network.

The IEs typically include a one-byte element ID field, a one-byte length field, and a 256-byte information field. The element ID field contains information indicating the type of IE, the length field contains information indicating a length of the IE, and the information field contains the actual information to be conveyed (e.g., to a recipient device) by the IE.

The one-byte element ID field includes 8 bits (one byte), and may therefore represent up to 2⁸=256 different element ID numbers. For example, an element ID number=0 may indicate that the information field of the IE contains SSID information, and an element ID number=1 may indicate that the information field of the IE contains supported data rates. As wireless networks become more ubiquitous, the number of assigned element ID numbers has increased, which in turn has left fewer element ID numbers available for new or additional types of IEs.

Thus, it would be desirable to increase the number of different element ID numbers that may be represented in an IE without significantly increasing the size of the IE and without altering existing parsers of various wireless devices.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

An apparatus and methods are disclosed that may increase the number of different element ID numbers that may be represented in an information element (IE) without significantly increasing the size of the IE and without altering existing parsers of various wireless devices. In accordance with example embodiments, an IE may include a one-byte element ID field, a length field, an N-byte element ID extension field, and an information field. The one-byte element ID field may represent up to 2⁸=256 possible values; 255 of these 256 possible values may represent unique element ID numbers, and one of these 256 possible values may be designated as a pointer to the N-byte element ID extension field, which may store up to 2^{N} additional unique element ID numbers. For one example, the IE includes a one-byte element ID extension field, which allows the IE to store up to 255+256=511 unique element ID numbers with a one-byte increase in IE frame length (e.g., as compared with conventional IEs). For another example, the IE includes a two-byte element ID extension field, which allows the IE to store up to 255+2¹⁶=255+65,536=65,791 unique element ID numbers with a two-byte increase in IE frame length (e.g., as compared with conventional IEs).

An example method of a first wireless device receiving information from a second wireless device may include receiving a frame including an information element (IE) comprising an N-bit element ID field for storing a first element ID number having 2^{N} possible values, wherein a designated value of the first element ID number comprises a pointer to at least one additional element ID number stored in a subsequent field of the frame, an element ID extension field for storing a second element ID number, the second element ID number identified by the pointer, and an information field for storing the information; and parsing the IE to identify a type of the IE. The type of the IE may be identified by one member of the group consisting of the first element ID number and the second element ID number. For at least some embodiments, wherein the element ID extension field comprises a number M of bits, the second element ID number has 2^{M} possible values, and the IE is configured to represent any one of a number P=2^{N}+2^{M}−1 of different IE types.

For some example embodiments, the first wireless device may parse the IE by: extracting the first element ID number from the element ID field; determining whether the first element ID number is the designated value; and identifying the type of the IE using either the first element ID number or the second element ID number in response to the determining.

For some example embodiments, the first wireless device may identify the type of IE by: if the first element ID number is not the designated value, identifying the type of the IE using the extracted first element ID number; and if the first element ID number is the designated value, then extracting the second element ID number from the element ID extension field; and identifying the type of the IE using the extracted second element ID number.

The example embodiments may also describe:

1. A method, performed by a second wireless device, for transmitting information to a first wireless device, the method comprising:
creating a frame including an information element (IE) comprising:
   an N-bit element ID field for storing a first element ID number having 2^{N} possible values, wherein a designated value of the first element ID number comprises a pointer to at least one additional element ID number stored in a subsequent field of the frame;
   an element ID extension field for storing a second element ID number, the second element ID number identified by the pointer; and
   an information field for storing the information; and
transmitting the frame to the first wireless device.

2. The method of claim 1, wherein the creating further comprises:
selecting a type of the IE;
determining an element ID number value for the selected type of IE;
in response to the determined element ID number value being not greater than 255, storing the determined element ID number value as the first element ID number in the element ID field of the IE; and
in response to the determined element ID number value being greater than 255:
   storing the determined element ID number value as the second element ID number in the element ID extension field of the IE;
   setting the first element ID number to the designated value; and
   storing the first element ID number in the element ID field of the IE.

3. The method of claim 2, wherein the type of IE is identified by one member of the group consisting of the first element ID number and the second element ID number.

4. The method of claim 1, wherein the element ID extension field comprises a number M of bits, the second element ID number has 2^{M} possible values, and the IE is configured to represent any one of a number P=2^{N}+2^{M}−1 of different IE types.

5. The method of claim 4, wherein N=8, M=8, the information field is 255 bytes, and a length of the IE is 258 bytes.

6. The method of claim 5, further comprising:

in response to the determined element ID number value being not greater than 255, omitting the element ID extension field of the IE.

### BRIEF DESCRIPTION OF THE DRAWINGS

The example embodiments are illustrated by way of example and are not intended to be limited by the figures of the accompanying drawings. Like numbers reference like elements throughout the drawings and specification.

FIG. 1 shows a block diagram of a WLAN system within which the example embodiments may be implemented.

FIG. 2 shows a block diagram of a wireless station (STA) in accordance with example embodiments.

FIG. 3 shows a block diagram of an access point (AP) in accordance with example embodiments.

FIG. 4 shows an example format of an information element (IE).

FIG. 5A shows one example format of an IE including a one-byte element ID extension field in accordance with example embodiments.

FIG. 5B shows an embodiment of the IE of FIG. 5A containing an element ID number that is designated as a pointer to the element ID extension field of the IE.

FIG. 6A shows another example format of an IE including a one-byte element ID extension field in accordance with example embodiments.

FIG. 6B shows one embodiment of the IE of FIG. 6A containing an element ID number that is designated as a pointer to the element ID extension field of the IE.

FIG. 6C shows another embodiment of the IE of FIG. 6A containing an element ID number that is designated as a pointer to the element ID extension field of the IE.

FIG. 7A shows an example format of an IE including a two-byte element ID extension field in accordance with example embodiments.

FIG. 7B shows an embodiment of the IE of FIG. 7A containing an element ID number that is designated as a pointer to the element ID extension field of the IE.

FIG. 8 is an illustrative flow chart depicting an example operation for creating a frame including an IE containing an element ID extension field in accordance with example embodiments.

FIG. 9A is an illustrative flow chart depicting an example operation for receiving a frame including an IE containing an element ID extension field in accordance with example embodiments.

FIG. 9B is an illustrative flow chart depicting an example operation for parsing the frame received in the operation of FIG. 9A.

### DETAILED DESCRIPTION

The example embodiments are described below in the context of Wi-Fi systems for simplicity only. It is to be understood that the example embodiments are equally applicable to other wireless networks (e.g., cellular networks, pico networks, femto networks, satellite networks), as well as for systems using signals of one or more wired standards or protocols (e.g., Ethernet and/or HomePlug/PLC standards). As used herein, the terms “WLAN” and “Wi-Fi®” may include communications governed by the IEEE 802.11 family of standards, BLUETOOTH® (Bluetooth), HiperLAN (a set of wireless standards, comparable to the IEEE 802.11 standards, used primarily in Europe), and other technologies having relatively short radio propagation range. Thus, the terms “WLAN” and “Wi-Fi” may be used interchangeably herein. In addition, although described below in terms of an infrastructure WLAN system including an AP and a plurality of STAs, the example embodiments are equally applicable to other WLAN systems including, for example, WLANs including a plurality of APs, peer-to-peer (or Independent Basic Service Set) systems, Wi-Fi Direct systems, and/or Hotspots. In addition, although described herein in terms of exchanging data packets between wireless devices, the example embodiments may be applied to the exchange of any data unit, packet, and/or frame between wireless devices. Thus, the term “frame” may include any frame, packet, or data unit such as, for example, protocol data units (PDUs), MAC protocol data units (MPDUs), and physical layer convergence procedure protocol data units (PPDUs). The term “A-MPDU” may refer to aggregated MPDUs.

In the following description, numerous specific details are set forth such as examples of specific components, circuits, and processes to provide a thorough understanding of the example disclosure. The term “coupled” as used herein means connected directly to or connected through one or more intervening components or circuits. Also, in the following description and for purposes of explanation, specific nomenclature is set forth to provide a thorough understanding of the example embodiments. However, it will be apparent to one skilled in the art that these specific details may not be required to practice the example embodiments. In other instances, well-known circuits and devices are shown in block diagram form to avoid obscuring the example disclosure. The example embodiments are not to be construed as limited to specific examples described herein but rather to include within their scopes all embodiments defined by the appended claims.

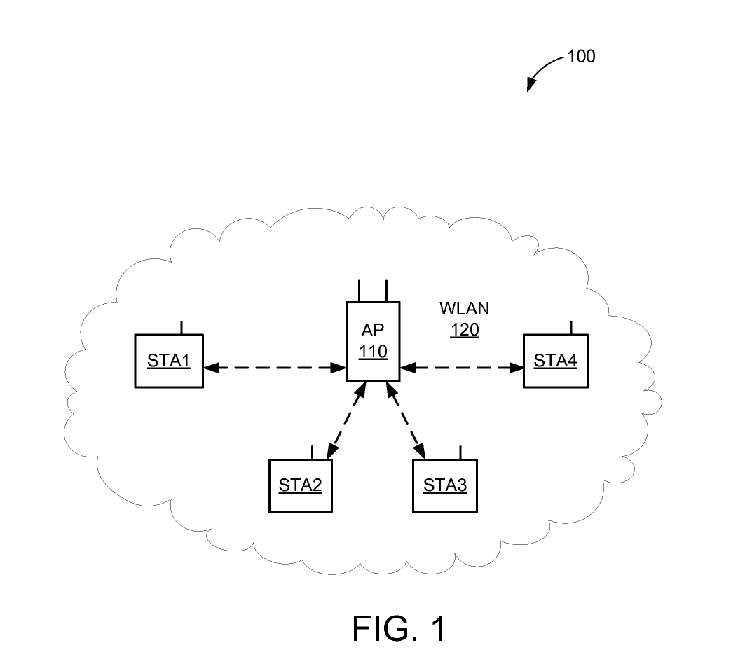

FIG. 1 is a block diagram of a wireless network system 100 within which the example embodiments may be implemented. The system 100 is shown to include four wireless stations STA1-STA4, a wireless access point (AP) 110, and a wireless local area network (WLAN) 120. The WLAN 120 may be formed by a plurality of Wi-Fi access points (APs) that may operate according to the IEEE 802.11 family of standards (or according to other suitable wireless protocols). Thus, although only one AP 110 is shown in FIG. 1 for simplicity, it is to be understood that WLAN 120 may be formed by any number of access points such as AP 110. The AP 110 is assigned a unique MAC address that is programmed therein by, for example, the manufacturer of the access point. Similarly, each of STA1-STA4 is also assigned a unique MAC address. For some embodiments, the wireless system 100 may correspond to a multiple-input multiple-output (MIMO) wireless network.

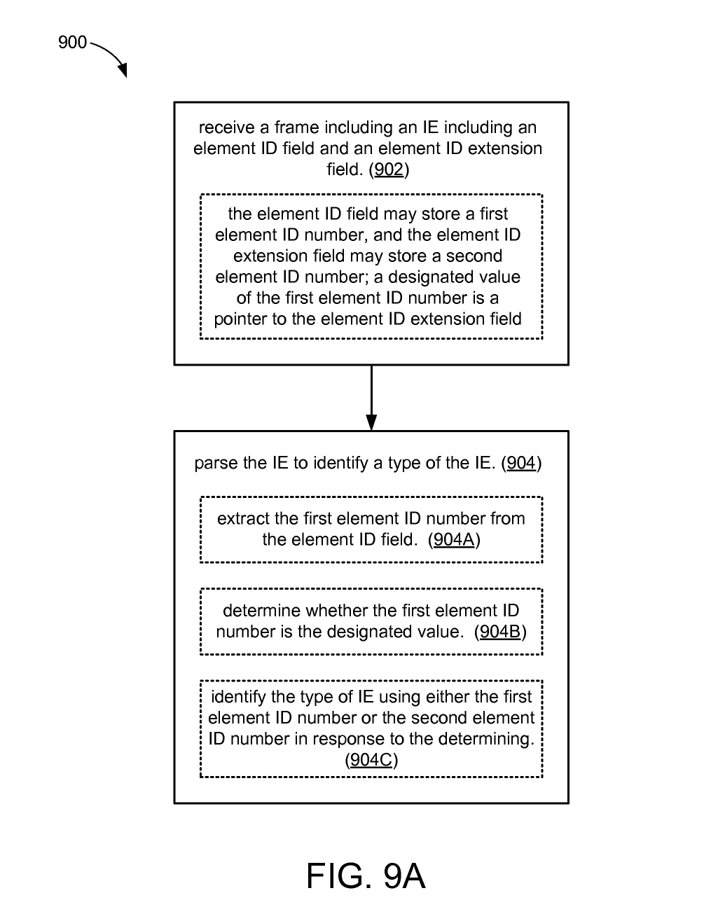

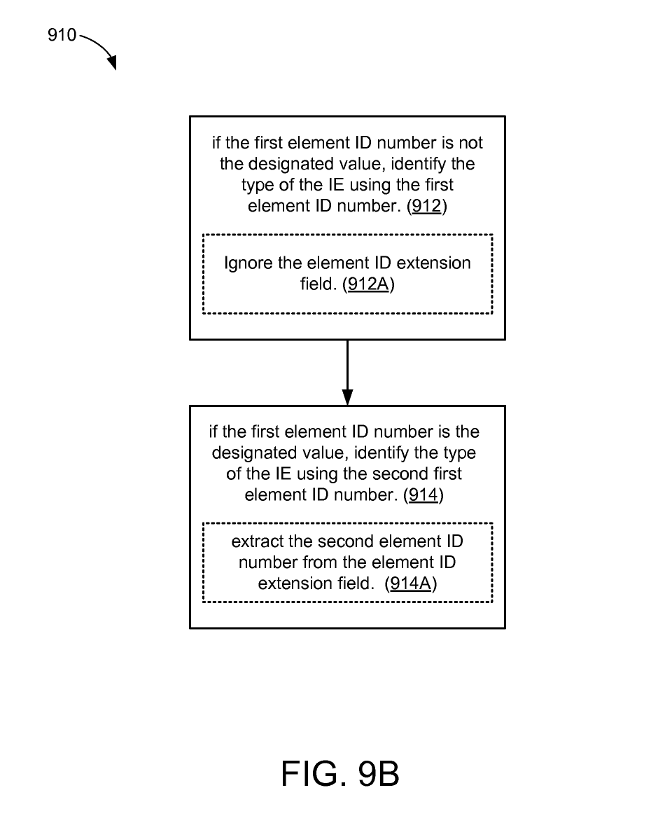

Each of stations STA1-STA4 may be any suitable Wi-Fi enabled wireless device including, for example, a cell phone, personal digital assistant (PDA), tablet device, laptop computer, or the like. Each station STA may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some embodiments, each station STA may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 8 and 9A-9B.

The one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 2.4 GHz frequency band and/or within a 5 GHz frequency band in accordance with the IEEE 802.11 specification. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). In other embodiments, the transceivers included within stations STA1-STA4 may be any technically feasible transceiver such as a ZigBee transceiver described by a specification from the ZigBee specification, a WiGig transceiver, and/or a HomePlug transceiver described a specification from the HomePlug Alliance.

The AP 110 may be any suitable device that allows one or more wireless devices to connect to a network (e.g., a local area network (LAN), wide area network (WAN), metropolitan area network (MAN), and/or the Internet) via AP 110 using Wi-Fi, Bluetooth, or any other suitable wireless communication standards. For at least one embodiment, AP 110 may include one or more transceivers, one or more processing resources (e.g., processors and/or ASICs), one or more memory resources, and a power source. The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 8 and 9A-9B.

The one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 2.4 GHz frequency band and/or within a 5 GHz frequency band in accordance with the IEEE 802.11 specification. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol).

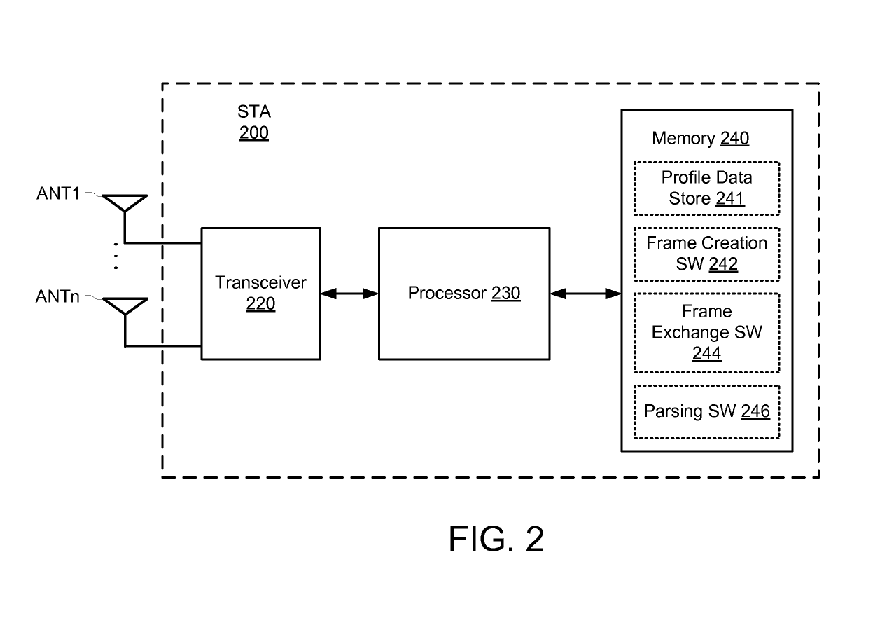

FIG. 2 shows a STA 200 that is one embodiment of at least one of the stations STA1-STA4 of FIG. 1. The STA 200 may include a transceiver 220, a processor 230, a memory 240, and a number of antennas (ANT1-ANTn). The transceiver 220 may be used to transmit signals to and receive signals from AP 110 and/or other STAs (see also FIG. 1) via one or more of antennas ANT1-ANTn. Transceiver 220 may also be used to scan the surrounding environment to detect and identify nearby access points (e.g., access points within range of STA 200 and/or other STAs). Transceiver 220 may include any suitable number of transmit chains and receive chains. For purposes of discussion herein, processor 230 is shown as coupled between transceiver 220 and memory 240. For actual embodiments, transceiver 220, processor 230, and/or memory 240 may be connected together using one or more buses (not shown for simplicity). Although only one transceiver 220 is shown in FIG. 2, actual embodiments may include any number of transceivers that may operate in any number of frequency bands and/or according to any number of different wireless communication protocols (e.g., as described above with respect to FIG. 1).

Memory 240 may include a profile data store 241 that stores profile information for a plurality of devices such as APs and/or other STAs. The profile information for a particular device may include information including, for example, the device's SSID, channel information, RSSI values, supported data rates, and any other suitable information pertaining to or describing the operation of the device.

Memory 240 may also include a non-transitory computer-readable medium (e.g., one or more nonvolatile memory elements, such as EPROM, EEPROM, Flash memory, a hard drive, and so on) that may store the following software (SW) modules:
a frame creation software module 242 to create frames (e.g., data frames, ACK frames, request frames, response frames, beacon frames, management frames, association frames, control frames, and so on) that may include an IE containing one or more element ID extension fields in accordance with the example embodiments;
a frame exchange software module 244 to facilitate the exchange of frames (e.g., data frames, ACK frames, request frames, response frames, beacon frames, management frames, association frames, control frames, and so on) with one or more other wireless devices; and
a parsing software module 246 to parse received frames to extract information including, for example, element ID numbers stored in element ID fields and/or stored in element ID extension fields of an IE created in accordance with the example embodiments.
   The frame creation software module 242, the frame exchange software module 244, and the parsing software module 246 each include instructions that, when executed by processor 230, may cause STA 200 to perform the corresponding functions. The non-transitory computer-readable medium of memory 240 thus includes instructions for performing all or a portion of the operations depicted in FIGS. 8 and 9A-9B.

Processor 230, which is coupled to transceiver 220 and to memory 240, may be any suitable one or more processors capable of executing scripts or instructions of one or more software programs stored in STA 200 (e.g., within memory 240). For example, processor 230 may execute the frame creation software module 242 to create frames (e.g., data frames, ACK frames, request frames, response frames, beacon frames, management frames, association frames, control frames, and so on) that may include an IE containing one or more element ID extension fields in accordance with the example embodiments. Processor 230 may also execute the frame exchange software module 244 to facilitate the exchange of various types of frames with one or more other wireless devices. Processor 230 may also execute the parsing software module 246 to parse received frames to extract information including, for example, element ID numbers stored in element ID fields and/or stored in element ID extension fields of an IE created in accordance with the example embodiments.

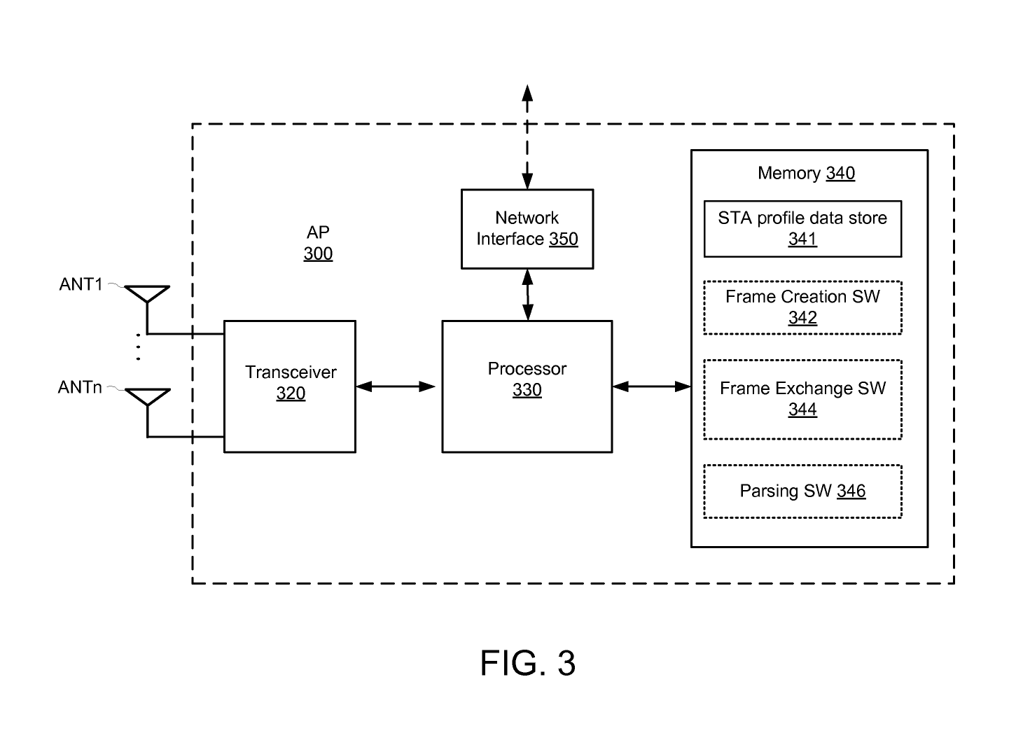

FIG. 3 shows an example AP 300 that may be one embodiment of AP 110 of FIG. 1. AP 300 includes a transceiver 320, a processor 330, a memory 340, a network interface 350, and a number of antennas (ANT1-ANTn). The transceiver 320 may be used to communicate wirelessly with one or more STAs, with one or more other APs, and/or with other suitable devices via one or more of antennas ANT1-ANTn. The network interface 350 may be used to communicate with a WLAN server (not shown for simplicity) either directly or via one or more intervening networks and to transmit signals. Processor 330, which is coupled to transceiver 310, to memory 340, and to network interface 350, may be any suitable one or more processors capable of executing scripts or instructions of one or more software programs stored in AP 300 (e.g., within memory 340). For purposes of discussion herein, processor 330 is shown as being coupled between transceiver 320 and memory 340. For actual embodiments, transceiver 320, processor 330, memory 340, and/or network interface 350 may be connected together using one or more buses (not shown for simplicity).

Memory 340 may include a STA profile data store 341 that stores profile information for a plurality of STAs. The profile information for a particular STA may include information including, for example, its MAC address, supported data rates, connection history with AP 300, and any other suitable information pertaining to or describing the operation of the STA.

Memory 340 may also include a non-transitory computer-readable medium (e.g., one or more nonvolatile memory elements, such as EPROM, EEPROM, Flash memory, a hard drive, and so on) that may store at least the following software (SW) modules:
a frame creation software module 342 to create frames (e.g., data frames, ACK frames, request frames, response frames, beacon frames, management frames, association frames, control frames, and so on) that may include an IE containing one or more element ID extension fields in accordance with the example embodiments;
a frame exchange software module 344 to facilitate the exchange of frames (e.g., data frames, ACK frames, request frames, response frames, beacon frames, management frames, association frames, control frames, and so on) with one or more other wireless devices; and
a parsing software module 346 to parse received frames to extract information including, for example, element ID numbers stored in element ID fields and/or stored in element ID extension fields of an IE created in accordance with the example embodiments.
   Each software module includes instructions that, when executed by processor 330, cause AP 300 to perform the corresponding functions. The non-transitory computer-readable medium of memory 340 thus includes instructions for performing all or a portion of the AP-side operations depicted in FIGS. 8 and 9A-9B.

Processor 330, which is shown in the example of FIG. 3 as coupled to transceiver 320, to memory 340, and to network interface 350, may be any suitable one or more processors capable of executing scripts or instructions of one or more software programs stored in AP 300 (e.g., within memory 340). For example, processor 330 may execute the frame creation software module 342 to create frames (e.g., data frames, ACK frames, request frames, response frames, beacon frames, management frames, association frames, control frames, and so on) that may include an IE containing one or more element ID extension fields in accordance with the example embodiments.

Processor 330 may execute the frame exchange software module 344 to facilitate the exchange of frames (e.g., data frames, ACK frames, request frames, response frames, beacon frames, management frames, association frames, control frames, and so on) with one or more other wireless devices.

Processor 330 may execute the parsing software module 346 to parse received frames to extract information including, for example, element ID numbers stored in element ID fields and/or stored in element ID extension fields of an IE created in accordance with the example embodiments.

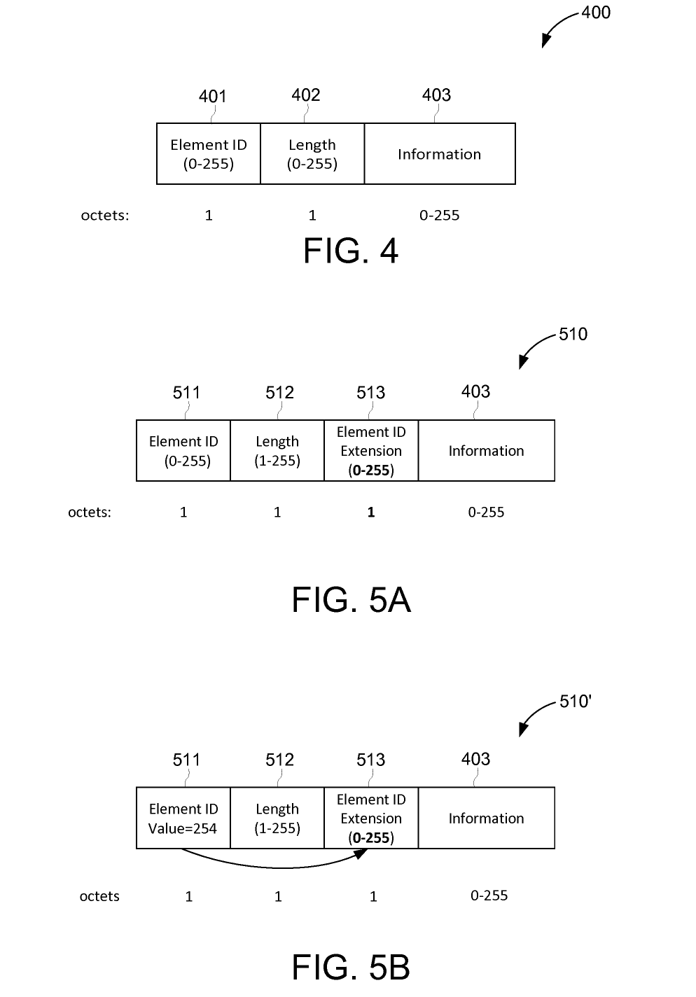

As mentioned above, the element ID field of existing IEs may soon run out of available values to assign to new and/or additional types of information elements. For example, FIG. 4 shows an example format of an information element (IE) 400. The IE 400 includes a one-byte element ID field 401, a one-byte length field 402, and a 256-byte information field 403. The one-byte element ID field 401 may represent up to 2⁸=256 possible values for element ID numbers, which may no longer be sufficient to represent new or additional types of IEs.

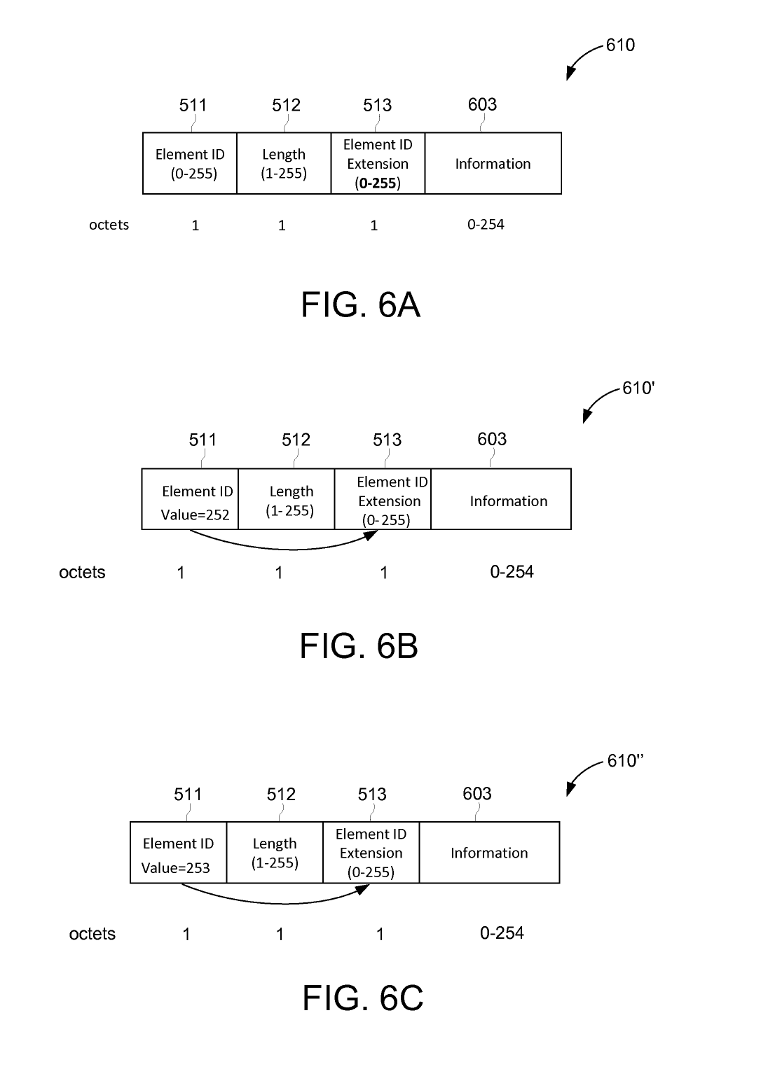

FIG. 5A shows an example format of an IE 510 in accordance with example embodiments. The IE 510 includes a one-byte element ID field 511, a one-byte length field 512, a one-byte element ID extension field 513, and a 256-byte information field 403. The one-byte element ID field 511 may represent up to 2⁸=256 possible values for element ID numbers, and the one-byte element ID extension field 513 may represent up to 2⁸=256 additional element ID numbers. For example embodiments, one of the possible 256 values of the element ID number stored in the element ID field 511 may be designated as a pointer to the one-byte element ID extension field 513. As used herein, an element ID number stored in the element ID field 511 may be referred to as the “first element ID number,” and an element ID number stored in the element ID extension field 513 may be referred to as the “second element ID number.”

As explained in more detail below with respect to FIG. 5B, when the first element ID number in element ID field 511 is the designated value, then a receiving device (e.g., a device that is parsing IE 510 for information) is to extract the second element ID number stored in the element ID extension field 513 (e.g., rather than the first element ID number stored in the element ID field 511) to determine the type of IE 510. Because the designated value of the first element ID number stored in element ID field 511 consumes one of the 256 possible values, the IE 510 of FIG. 5A may increase the number of possible values for an element ID number from 256 to 255+256=511 with a one-byte increase in IE frame length (e.g., as compared with IE 400 of FIG. 4).

FIG. 5B shows an IE 510′ that is the IE 510 of FIG. 5A having a first element ID number stored in element ID field 511 set to a designated value=254 (although other suitable values of the first element ID number may be the designated value). When a receiving device (not shown in FIG. 5B) receives the IE 510′ of FIG. 5B, the receiving device may extract the first element ID number stored in element ID field 511. The receiving device may then compare the extracted first element ID number with a stored number indicative of the designated value. For the example of FIG. 5B, the extracted first element ID number has a value=254, which is the designated value. In response thereto, the receiving device may then jump to the element ID extension field 513 and extract the second element ID number stored therein. The receiving device may then use the second element ID number extracted from the element ID extension field 513 to identify a type of the IE 510′. Note that if the first element ID number extracted from element ID field 511 is not the designated value, then the receiving device may use the first element ID number extracted from element ID field 511 to identify the type of the IE 510′.

For example embodiments, the receiving device may concatenate a binary “1” as the most significant bit (MSB) to the second element ID number extracted from element ID extension field 513 (e.g., so that the resulting concatenated element ID number has binary values ranging from 256 to 510).

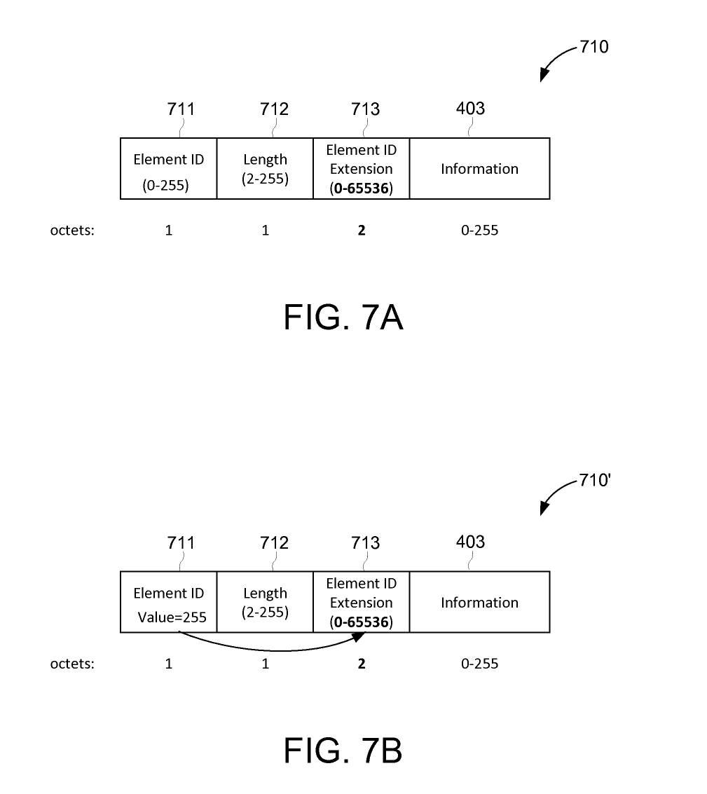

FIG. 6A shows an example format of another IE 610 in accordance with example embodiments. IE 610 is similar to IE 510 of FIG. 5A, except that the IE 610 includes a 255-byte information field 603 (rather than the 256-byte information field 403 of FIG. 5A). More specifically, although IE 610 may store up to 511 possible values of element ID numbers (255 possible values in element ID field 511 plus 265 possible values in element ID extension field 513), the element ID extension field 513 of IE 610 effectively “borrows” one of the bytes from the information field 604. As a result, the IE 610 of FIG. 6A may store up to 511 possible values of the element ID number and yet have the same length (e.g., size) as IE 400 of FIG. 4. In this manner, IEs such as IE 610 may represent nearly twice the number of possible element ID values without any increase in size (e.g., as compared to the IE 410 of FIG. 4).

FIG. 6B shows an IE 610′ that is the IE 610 of FIG. 6A having a first element ID number stored in element ID field 511 set to a designated value=252 (although other suitable values of the first element ID number may be the designated value). When a receiving device (not shown in FIG. 6B) extracts the first element ID number=252 from the element ID field 511 of IE 610′, the receiving device may jump to the element ID extension field 513 and use the second element ID number extracted from the element ID extension field 513 to identify a type of the IE 610′. Note that if the first element ID number extracted from element ID field 511 is not the designated value, then the receiving device may use the first element ID number extracted from element ID field 511 to identify the type of the IE 610′.

FIG. 6C shows an IE 610″ that is the IE 610 of FIG. 6A having a first element ID number stored in element ID field 511 set to a designated value=253 (although other suitable values of the first element ID number may be the designated value). When a receiving device (not shown in FIG. 6C) extracts the first element ID number=253 from the element ID field 511 of IE 610″, the receiving device may jump to the element ID extension field 513 and use the second element ID number extracted from the element ID extension field 513 to identify a type of the IE 610″. Note that if the first element ID number extracted from element ID field 511 is not the designated value, then the receiving device may use the first element ID number extracted from element ID field 511 to identify the type of the IE 610″.

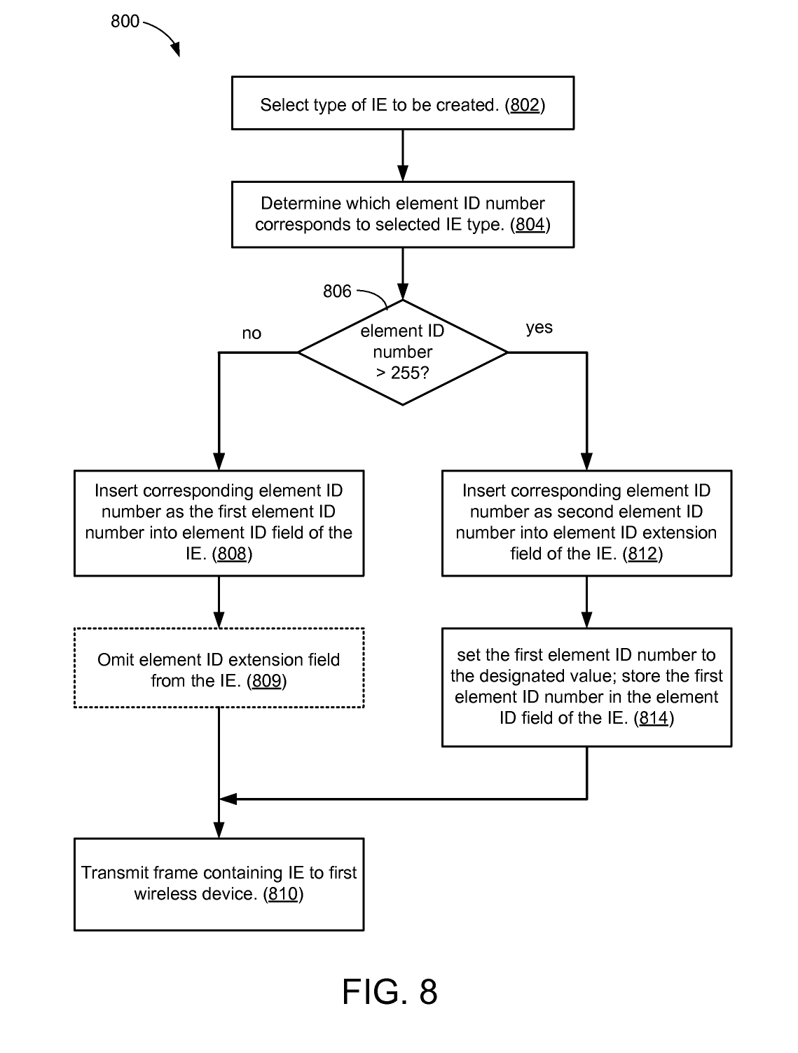

FIG. 7A shows an example format of another IE 710 in accordance with example embodiments. The IE 710 includes a one-byte element ID field 711, a one-byte length field 712, a two-byte element ID extension field 713, and a 256-byte information field 403. The one-byte element ID field 711 may represent up to 2⁸=256 possible values for element ID numbers, and the two-byte element ID extension field 713 may represent up to 2¹⁶=65,536 additional element ID numbers. For example embodiments, one of the possible 256 values of the first element ID number stored in the element ID field 711 may be designated as a pointer to the two-byte element ID extension field 713. Thus, when the first element ID number stored in element ID field 711 is the designated value, then a receiving device is to extract the second element ID number stored in the element ID extension field 713 (e.g., rather than the first element ID number stored in the element ID field 711) to determine the type of IE 710. Because the designated value of the first element ID number stored in element ID field 711 consumes one of the 256 possible element ID values, the IE 710 of FIG. 7A may increase the number of possible values for an element ID number from 256 to 255+65,536=65,791 with a two-byte increase in IE frame length (e.g., as compared with IE 400 of FIG. 4).

FIG. 7B shows an IE 710′ that is the IE 710 of FIG. 7A having a first element ID number stored in element ID field 711 set to a designated value=255 (although other suitable values of the first element ID number may be the designated value). When a receiving device (not shown in FIG. 7B) extracts the first element ID number=255 from the element ID field 711 of IE 710′, the receiving device may jump to the element ID extension field 713 and use the second element ID number extracted from the element ID extension field 713 to identify a type of the IE 710′. Note that if the first element ID number extracted from element ID field 711 is not the designated value, then the receiving device may use the first element ID number extracted from element ID field 711 to identify the type of the IE 710′.

For other example embodiments, IEs may include a collection of 2 or more one-byte element ID extension fields and/or a two-byte element ID extension field. For such embodiments, each of the one-byte element ID extension fields may be pointed to by a first element ID number having designated values of 254 and lower in the element ID field of the IE, and the two-byte element ID extension field may be pointed to by a second element ID number having a designated value of 255 in the element ID field of the IE.

The following tables illustrate the number of added elements ID numbers with a 1-byte increase in IE size (e.g., as compared to IE 400 of FIG. 4), in the various possible element ID number assignments.

TABLE 1

| | Element | Maximum | | | New Elements |
|---|---|---|---|---|---|
| | ID | size of | Element | | with |
| Element | Extension | Information | IDs | Additional | 1 octet |
| ID | Field Size | Field | Added | Overhead | overhead |
| 252 | 1 octet | 254 octets | ~256 | 1 octet | ~768 |
| 253 | 1 octet | 254 octets | ~256 | 1 octet | |
| 254 | 1 octet | 254 octets | ~256 | 1 octet | |
| 255 | 2 octets | 253 octets | 65536 | 2 octets | |

TABLE 2

| | Element | Maximum | | | New Elements |
|---|---|---|---|---|---|
| | ID | size of | Element | | with |
| Element | Extension | Information | IDs | Additional | 1 octet |
| ID | Field Size | Field | Added | Overhead | overhead |
| 253 | 1 octet | 254 octets | ~256 | 1 octet | ~512 |
| 254 | 1 octet | 254 octets | ~256 | 1 octet | |
| 255 | 2 octets | 253 octets | 65536 | 2 octets | |

TABLE 3

| | Element | Maximum | | | New Elements |
|---|---|---|---|---|---|
| | ID | size of | Element | | with |
| Element | Extension | Information | IDs | Additional | 1 octet |
| ID | Field Size | Field | Added | Overhead | overhead |
| 254 | 1 octet | 254 octets | ~256 | 1 octet | ~256 |
| 255 | 2 octets | 253 octets | 65536 | 2 octets | |

Specifically, Table 1 depicts example IEs that provide 512 additional values for an element ID number, and Table 2 depicts example IEs that provide 68 additional values for an element ID number. The first row of Table 3 depicts IE 510′ of FIG. 5B (which provides 256 additional values for the element ID number), and the second row of Table 3 depicts IE 710′ of FIG. 7B (which provides 65,536 additional values for the element ID number).

An example operation 800 for creating and transmitting an IE including an element ID extension field is described below with respect to the flow chart of FIG. 8 and with respect to the IE 510 shown in FIG. 5A. As discussed above, the IE 510 includes a one-byte element ID field 511, a one-byte length field 512, a one-byte element ID extension field 513, and 256-byte information field 403. The element ID field 511 stores a first element ID number having 256 possible values, one of which being designated as a pointer to a second element ID number stored in the element ID extension field 513. The second element ID number has 256 possible values, which as discussed above allows the IE 510 to store up to 511 different values of an element ID number (and thus the IE 510 may be any one of up to 511 different IE types). For other embodiments, the operation 800 may be performed on other example IEs disclosed herein (e.g., with respect to FIG. 5B, 6A-6C, and 7A-7B).

For the operation 800 described below, a second wireless device is to create and transmit an IE 510 to a first wireless device. The first wireless device may be either one of stations STA1-STA4 or AP 110 of FIG. 1, and the second wireless device may be either one of stations STA1-STA4 or AP 110 of FIG. 1. Thus, the operation described below may be performed by a STA receiving IE 510 from an AP or another STA, or may be performed by an AP receiving IE 510 from a STA or another AP.

The second wireless device may select an IE type for the IE to be created in accordance with example embodiments (802). The second wireless device may then determine which element ID number corresponds to (e.g., identifies) the selected IE type (804). The second wireless device may then determine whether the corresponding element ID number is greater than (or not greater than 255) (806).

If the corresponding element ID number is not greater than 255, as tested at 806, then the second wireless device may insert the corresponding element ID number as the first element ID number into the element ID field 511 of the IE 510 (808). For one example, if the information field 403 of IE 510 is to contain SSID information, then the element ID number=0 (e.g., the IE type is “SSID”). For another example, if the information field 403 of IE 510 is to contain supported data rates, then the element ID number=1 (e.g., the IE type is “supported data rates”).

Because the corresponding element ID number may be represented by the 8 bits in the element ID field 511, the element ID extension field 513 is not needed. For one example, the second wireless device may omit element ID extension field 513 from IE 510 (e.g., to reduce its size to that of IE 400 of FIG. 4) (809). For another example, the second wireless device may insert dummy data (e.g., padding zero's or ones) into element ID extension field 513. Thereafter, the second wireless device may transmit a frame containing the IE 510 (or alternatively containing the IE 400 of FIG. 4) to the first wireless device (810).

Conversely, if the corresponding element ID number is greater than 255, as tested at 806, then the second wireless device may insert the corresponding element ID number as the second element ID number into the element ID extension field 513 of the IE 510 (812). Because the example element ID extension field 513 is a one-byte field, the element ID extension field 513 may store up to 2⁸=256 different values. Thus, for at least some example embodiments, the second wireless device may strip the binary “1” MSB from the corresponding element ID number prior to storage as the second element ID number into the element ID extension field 513. For example, if the corresponding element ID number is 260 (which has a 9-bit binary representation of “100000101”), then the second wireless device may set the second element ID number to the binary equivalent of 5 (e.g., “00000101”) for storage in element ID extension field 513 (e.g., by stripping the “1” MSB prior to storage in the element ID extension field 513). Thereafter, when the first wireless device receives the frame including the IE 510, the first wireless device may extract the value “00000101” from element ID extension field 513 and concatenate a “1” as the MSB to reconstruct the binary value “100000101.”

The second wireless device may then set the first element ID number to the designated value, and store the designated value as the first element ID number in the element ID field 511 of IE 510 (814). As described above, when the first element ID number is set to the designated value, the first element ID number acts as a pointer to the second element ID number stored in the element ID extension field 513. This may ensure that when the first wireless device extracts the first element ID number from the element ID field 511, the first wireless device will be pointed to the second element ID number stored in the element ID extension field 513.

An example operation for receiving the IE 510 created and transmitted in the operation 800 of FIG. 8 is described below with respect to the flow chart 900 of FIG. 9A. The first wireless device receives the frame including the IE 510 (902). As described above with respect to FIG. 5A, the IE 510 includes an element ID field 511 for storing a first element ID number, and includes an element ID extension field 513 for storing a second element ID number; if the first element ID number is of the designated value, then the first element ID number is a pointer that identifies the second element ID number stored in the element ID extension field 513.

Then, the first wireless device parses the IE 510 to identify a type of the IE 510 (904). More specifically, the first wireless device may first extract the first element ID number from the element ID field 511 (904A), determine whether the first element ID number is the designated value (904B), and then identify the type of the IE using either the first element ID number or the second element ID number in response to the determining (904C).

FIG. 9B shows an illustrative flow chart 910 depicting an example operation for using either the first element ID number or the second element ID number to identify the type of the IE 510. If the first element ID number is not the designated value, then the first wireless device may identify the type of IE 510 using the first element ID number stored in the element ID field 511 (912). For example embodiments, the first wireless device may ignore the element ID extension field 513 (912A).

Conversely, if the first element ID number is the designated value, then the first wireless device may identify the type of the IE 510 using the second element ID number stored in the element ID extension field 513 (914). For example embodiments, the first wireless device may extract the second element ID number from the element ID extension field 513 to identify the type of IE 510 (914A). For at least some embodiments, the first wireless device may concatenate a “1” as the MSB to the extracted second element ID number, and then use the resulting concatenated element ID number to identify the type of the IE 510.

In the foregoing specification, the embodiments have been described with reference to specific exemplary embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense. For example, in other embodiments, bits of the element ID field and bits of the element ID extension field(s) may be concatenated to provide an even greater number of new element ID values.

What is claimed is:

1. A method, performed by a first wireless device, for receiving information from a second wireless device, the method comprising:
receiving a frame including an information element (IE) comprising:
an N-bit element ID field for storing a first element ID number having 2^{N} possible values, wherein a designated value of the first element ID number comprises a pointer to at least one additional element ID number stored in a subsequent field of the frame;
an element ID extension field for storing a second element ID number, the second element ID number identified by the pointer; and
an information field for storing the information; and
parsing the IE to identify a type of the IE.

2. The method of claim 1, wherein the type is identified by one member of the group consisting of the first element ID number and the second element ID number.

3. The method of claim 1, wherein the element ID extension field comprises a number M of bits, the second element ID number has 2^{M} possible values, and the IE is configured to represent any one of a number P=2^{N}+2^{M}−1 of different IE types.

4. The method of claim 3, wherein N=8, M=8, the information field is 255 bytes, and a length of the IE is 258 bytes.

5. The method of claim 1, wherein parsing the IE comprises:
extracting the first element ID number from the element ID field;
determining whether the first element ID number is the designated value; and
identifying the type of the IE using either the first element ID number or the second element ID number in response to the determining.

6. The method of claim 5, wherein the identifying comprises:
if the first element ID number is not the designated value, identifying the type of the IE using the extracted first element ID number; and
if the first element ID number is the designated value,
extracting the second element ID number from the element ID extension field; and
identifying the type of the IE using the extracted second element ID number.

7. The method of claim 6, further comprising:
if the first element ID number is not the designated value, ignoring the element ID extension field.

8. The method of claim 6, further comprising:
if the first element ID number is the designated value, adding a logical “1” as a most significant bit to the extracted second element ID number.

9. A first wireless device, comprising:
a transceiver to exchange wireless signals with at least a second wireless device;
one or more processors; and
a memory storing instructions that, when executed by the one or more processors, causes the first wireless device to:
receive a frame including an information element (IE) comprising:
an N-bit element ID field for storing a first element ID number having 2^{N} possible values, wherein a designated value of the first element ID number comprises a pointer to at least one additional element ID number stored in a subsequent field of the frame;
an element ID extension field for storing a second element ID number, the second element ID number identified by the pointer; and
an information field for storing information; and
parse the IE to identify a type of the IE.

10. The first wireless device of claim 9, wherein the type is identified by one member of the group consisting of the first element ID number and the second element ID number.

11. The first wireless device of claim 9, wherein the element ID extension field comprises a number M of bits, the second element ID number has 2^{M} possible values, and the IE is configured to represent any one of a number P=2^{N}+2^{M}−1 of different IE types.

12. The first wireless device of claim 11, wherein N=8, M=8, the information field is 255 bytes, and a length of the IE is 258 bytes.

13. The first wireless device of claim 9, wherein execution of the instructions to parse the IE causes the first wireless device to:
extract the first element ID number from the element ID field;
determine whether the first element ID number is the designated value; and
identify the type of the IE using either the first element ID number or the second element ID number in response to the determining.

14. The first wireless device of claim 13, wherein execution of the instructions to identify the type causes the first wireless device to:
if the first element ID number is not the designated value, identify the type of the IE using the extracted first element ID number; and
if the first element ID number is the designated value,
extract the second element ID number from the element ID extension field; and
identify the type of the IE using the extracted second element ID number.

15. The first wireless device of claim 14, wherein execution of the instructions further causes the first wireless device to:
ignore the element ID extension field if the first element ID number is not the designated value.

16. The first wireless device of claim 14, wherein execution of the instructions further causes the first wireless device to:
add a logical “1” as a most significant bit to the extracted second element ID number if the first element ID number is the designated value.

17. A non-transitory computer-readable medium storing instructions that, when executed by one or more processors of a first wireless device, causes the first wireless device to perform operations comprising:
receiving, from a second wireless device, a frame including an information element (IE) comprising:
an N-bit element ID field for storing a first element ID number having 2^{N} possible values, wherein a designated value of the first element ID number comprises a pointer to at least one additional element ID number stored in a subsequent field of the frame;
an element ID extension field for storing a second element ID number, the second element ID number identified by the pointer; and
an information field for storing the information; and
parsing the IE to identify a type of the IE.

18. The non-transitory computer-readable medium of claim 17, wherein the type is identified by one member of the group consisting of the first element ID number and the second element ID number.

19. The non-transitory computer-readable medium of claim 17, wherein the element ID extension field comprises a number M of bits, the second element ID number has 2^{M} possible values, and the IE is configured to represent any one of a number P=2^{N}+2^{M -1} of different IE types.

20. The non-transitory computer-readable medium of claim 19, wherein N=8, M=8, the information field is 255 bytes, and a length of the IE is 258 bytes.

21. The non-transitory computer-readable medium of claim 17, wherein execution of the instructions to parse the IE causes the first wireless device to perform operations comprising:
extracting the first element ID number from the element ID field;
determining whether the first element ID number is the designated value; and
identifying the type of the IE using either the first element ID number or the second element ID number in response to the determining.

22. The non-transitory computer-readable medium of claim 21, wherein execution of the instructions to identify the type causes the first wireless device to perform operations comprising:
if the first element ID number is not the designated value, identifying the type of the IE using the extracted first element ID number; and
if the first element ID number is the designated value,
extracting the second element ID number from the element ID extension field; and
identifying the type of the IE using the extracted second element ID number.

23. The non-transitory computer-readable medium of claim 22, wherein execution of the instructions causes the first wireless device to perform operations further comprising:
ignoring the element ID extension field if the first element ID number is not the designated value.

24. The non-transitory computer-readable medium of claim 22, wherein execution of the instructions causes the first wireless device to perform operations further comprising:
adding a logical “1” as a most significant bit to the extracted second element ID number if the first element ID number is the designated value.

25. A first wireless device, comprising:
means for receiving, from a second wireless device, a frame including an information element (IE) comprising:
an N-bit element ID field for storing a first element ID number having 2^{N} possible values, wherein a designated value of the first element ID number comprises a pointer to at least one additional element ID number stored in a subsequent field of the frame;
an element ID extension field for storing a second element ID number, the second element ID number identified by the pointer; and
an information field for storing the information; and
means for parsing the IE to identify a type of the IE.

26. The first wireless device of claim 25, wherein the type is identified by one member of the group consisting of the first element ID number and the second element ID number.

27. The first wireless device of claim 25, wherein the element ID extension field comprises a number M of bits, the second element ID number has 2^{M} possible values, and the IE is configured to represent any one of a number P=2^{N}+2^{M}−1 of different IE types.

28. The first wireless device of claim 25, wherein the means for parsing is to:
extract the first element ID number from the element ID field;
determine whether the first element ID number is the designated value; and
identify the type of the IE using either the first element ID number or the second element ID number in response to the determining.

29. The first wireless device of claim 28, wherein the means for identifying is to:
if the first element ID number is not the designated value, identify the type of the IE using the extracted first element ID number; and
if the first element ID number is the designated value,
extract the second element ID number from the element ID extension field; and
identify the type of the IE using the extracted second element ID number.

30. The first wireless device of claim 28, further comprising:
means for ignoring the element ID extension field if the first element ID number is not the designated value.
